(19) United States
(12) Patent Application Publication
(10) Pub. No.: US 2003/0056810 A1
(43) Pub. Date: Mar. 27, 2003

(54) Tool for removing hair from a basin drain

(76) Inventor: Steven M. Petit, Bolingbrook, IL (US)

Correspondence Address: Thomas K. Stine, Wallenstein & Wagner, Ltd., 53rd Floor, 311 South Wacker Drive, Chicago, IL, 60606-6630, US

(21) Appl. No.: 10/242,820

(22) Filed: Sep. 13, 2002

Related U.S. Application Data
(60) Provisional application No. 60/323,978, filed on Sep. 21, 2001.

(51) Int. Cl. B08B 9/027

(52) U.S. Cl. 134/8; 15/104.05; 15/104.31; 15/104.32

(57) ABSTRACT

A tool for removing hair and other debris from a basin drain is disclosed. The tool comprises a shaft having a first end and a second end and a mid-section. The first shaft end forms a handle and the second shaft end forms a hook. A method of using the tool is also disclosed.

### CROSS-REFERENCE TO RELATED APPLICATIONS

This application claims priority from U.S. provisional patent application No. 60/323,978, filed Sep. 21, 2001.

### FEDERALLY SPONSORED RESEARCH OR DEVELOPMENT

Not Applicable.

### TECHNICAL FIELD

The present invention relates to a tool for removing hair or other debris from drains of basins, such as sinks or bathtubs, and to a method for using the tool.

### BACKGROUND OF THE INVENTION

Various attempts have been made to create a tool to remove hair from a basin drain. See for example U.S. Pat. No. 5,836,032. However, such tools do not provide for easy access to remove the hair from the drain.

The present invention is provided to solve this and other problems.

### SUMMARY OF THE INVENTION

It is an object of the invention to provide a tool for removing hair and other debris from a basin drain.

In accordance with the invention, the tool comprises a shaft having a first end, a second end and a mid-section. The first shaft end forms a handle and the second shaft end forms a hook.

It is contemplated that the shaft has a bend in its mid-section, and the bend forms an angle in the range of 16° to 20°, preferably 18°.

It is further contemplated that the shaft is formed of spring stainless steel.

It is still further contemplated that the handle comprises a loop of the shaft, and that the handle is plastic coated, preferably textured.

It is yet further contemplated that the tool has a length of 7½ inches.

It is further contemplated that the hook is generally pointed and that the tool is generally planar. Alternatively the handle and the hook end may be disposed at an angle, such that the tool is not generally planar.

It is a further object of the invention to provide a method for removing hair from a basin drain.

In accordance with this aspect of the invention, the method comprises providing a tool. The tool comprises a shaft having a first end and a second end and a mid-section. The first shaft end forms a handle and the second shaft end forms a hook. The hook is inserted into the drain and the hair is grasped with the hook and removed from the drain.

Other features and advantages of the invention will be apparent from the following specification taken in conjunction with the following drawings.

### BRIEF DESCRIPTION OF THE DRAWINGS:

FIG. 1 is a plan view of a tool in accordance with the invention; and

FIG. 2 is a side view of the tool of FIG. 1, illustrating a method of utilizing the tool to remove hair and other debris from a sink drain;

FIG. 3 is a plan view of an alternative embodiment of the invention.

### DETAILED DESCRIPTION OF THE INVENTION:

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

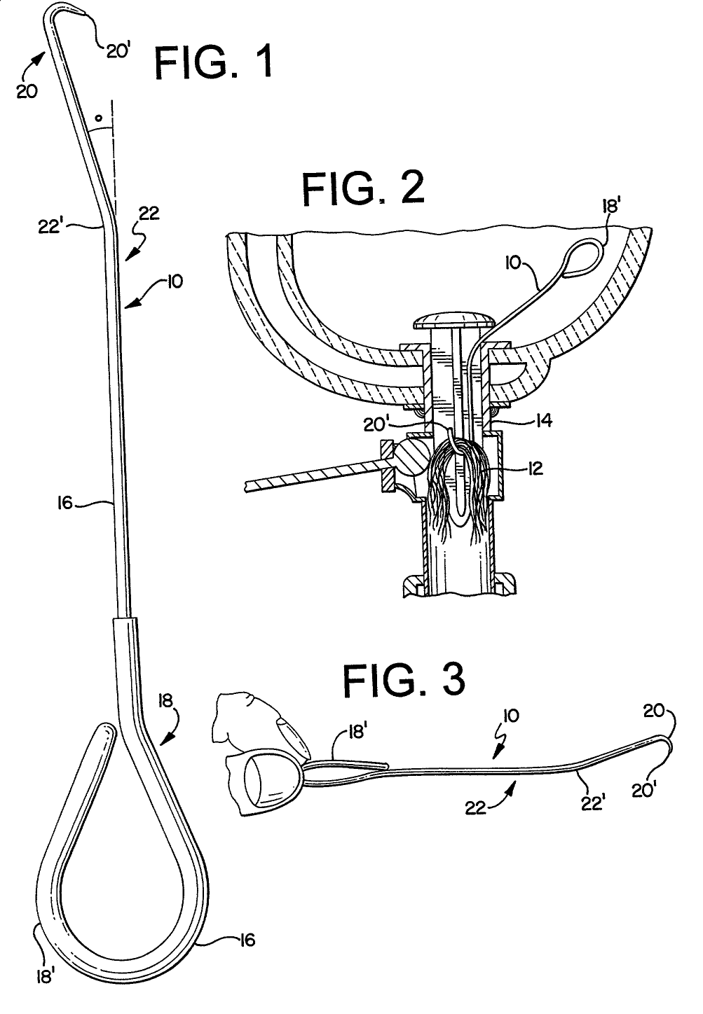

A tool 10 for removing hair 12 and other debris from a basin drain 14 is illustrated in FIGS. 1 and 2.

The tool 10 comprises a shaft 16 having a first end 18, a second end 20 and a midsection 22. The first shaft end 18 forms a handle 18′. The second shaft end 20 forms a hook 20′, having a radius of ⅛ inch, plus or minus 1/32 of an inch.

The shaft 16 has a bend 22′ in its mid-section 22. The bend 22′ is located 1.5 inches (+/−0.25 inches) from the bend 22′. The bend 22′ forms an angle in the range of 16° to 20°, preferably 18°. The shaft 16 is formed of rigid, spring stainless steel.

The handle comprises a loop of the shaft 16, and the handle is plastic coated, preferably textured. The tool 10 has a length of 7½ inches. The hook 20′ is generally pointed and the tool 10 is generally planar. Alternatively, as illustrated in FIG. 3, the handle 18′, and the hook 20′ may be disposed at a 90° angle, such that the tool is not generally planar.

A method for removing hair from a basin drain is disclosed in FIG. 2.

The method comprises providing the tool 10. The hook 20′ is inserted into the drain 14, and the hair 12 is grasped with the hook 20′ and removed from the drain 14.

While specific embodiments have been illustrated and described, numerous modifications come to mind without significantly departing from the spirit of the invention and the scope of protection is only limited by the scope of the accompanying Claims.

I claim:

1. A tool for removing hair and other debris from a basin drain comprising:
a shaft having a first end and a second end and a mid-section, wherein the first shaft end forms a handle and the second shaft end forms a hook.

2. The tool of claim 1 wherein the shaft has a bend in its mid-section.

3. The tool of claim 2 wherein the bend forms an angle in the range of 16° to 20°.

4. The tool of claim 3 wherein the bend angle is 18°.

5. The tool of claim 1 wherein the shaft is formed of spring stainless steel.

6. The tool of claim 1 wherein the handle comprises a loop of the shaft.

7. The tool of claim 6 wherein the handle is plastic coated.

8. The tool of claim 7 wherein the plastic coated handle is textured.

9. The tool of claim 1 wherein the tool has a length of 7½ inches.

10. The tool of claim 1 wherein the hook is generally pointed.

11. The tool of claim 1 wherein the tool is generally planar.

12. A tool for removing hair and other debris from a basin drain comprising:
a shaft having a first end and a second end and a mid-section, wherein:
the first shaft end is looped to form a handle;
the second shaft end forms a hook; and
the shaft has a bend in its mid-section.

13. The tool of claim 12 wherein the bend forms an angle in the range of 16° to 20°.

14. The tool of claim 13 wherein the bend angle is 18°.

15. The tool of claim 12 wherein the shaft is formed of spring stainless steel.

16. The tool of claim 12 wherein the handle is plastic coated.

17. The tool of claim 16 wherein the plastic coated handle is textured.

18. The tool of claim 12 wherein the tool has a length of 7½ inches.

19. The tool of claim 12 wherein the hook is generally pointed.

20. The tool of claim 12 wherein the tool is generally planar.

21. A method for removing hair from a basin drain, the method comprising:
providing a tool, the tool comprising a shaft having a first end and a second end and a mid-section, wherein the first shaft end forms a handle and the second shaft end forms a hook;
inserting the hook of the tool into the drain; and
grasping the hair with the hook and removing the hair.
